(19) United States
(12) Patent Application Publication
(10) Pub. No.: US 2006/0259380 A1
(43) Pub. Date: Nov. 16, 2006

(54) System and method for linking gemstones and insurance

(76) Inventors: Jeffrey Milstein, Schaumburg, IL (US); James Waszak, Darien, IL (US)

Correspondence Address: BRINKS HOFER GILSON & LIONE, P.O. BOX 10395, CHICAGO, IL, 60610, US

(21) Appl. No.: 11/399,302

(22) Filed: Apr. 6, 2006

Related U.S. Application Data
(60) Provisional application No. 60/669,246, filed on Apr. 7, 2005.

(51) Int. Cl. G06Q 99/00; G07G 1/14; G06Q 40/00; G06Q 30/00

(52) U.S. Cl. 705/35; 705/1; 705/14

(57) ABSTRACT

A supportable value product such as diamonds is guaranteed for an extended period of time so that an owner can return the product at any point over the guarantee period for a complete refund of the amount paid for the product. The products are covered by an insurance policy by a respected insurance carrier so that if the owner wishes to return the product, the total amount paid for the product is refunded. The insurance policy covers at most the retail price less the wholesale price paid to the seller. The products, for example gemstones such as diamonds, are characterized and identified with a unique identification before being mounted and sold via a store or through the television or internet. The merchant coordinates and controls interactions and data between various entities such that the products are quickly prepared and shipped to the customer and the entities are paid within a short period of time.

### RELATED APPLICATIONS

The present application claims the benefit of U.S. Provisional Application Ser. No. 60/669,246, filed Apr. 7, 2005, pending, the entirety of which is incorporated herein by reference.

### TECHNICAL FIELD

The present application relates to transactions involving supportable value products, such as gemstones and/or jewelry, and linking insurance to that transaction.

### BACKGROUND

The retail jewelry market in the United States is estimated to have generated $27.7 billion in retail sales in 2003, not including department stores and discount stores. As shown in Table 1, this is a 6.9% increase over the previous year. The data for Table 1 can be found at the U.S. Department of Commerce at http://www.census.gov/econ/census02/. Similar increases, with a few scattered decreases indicate that jewelry sales are primarily increasing from year-to-year. The average increase is 5.5%. Of the $27.7 billion in jewelry, $6.7 billion is estimated to be in solitaire diamond rings, diamond pendants, and diamond earrings.

TABLE 1

| Year | Total | % Inc/Dec Prev. Year |
|---|---|---|
| 2003 | $27,092,000,000 | 6.9% |
| 2002 | $25,344,000,000 | 4.8% |
| 2001 | $24,176,000,000 | −4.6% |
| 2000 | $25,338,000,000 | 5.3% |
| 1999 | $24,068,000,000 | 11.8% |
| 1998 | $21,527,000,000 | 8.8% |
| 1997 | $19,778,000,000 | −2.7% |
| 1996 | $20,317,000,000 | 6.1% |
| 1995 | $19,152,000,000 | 6.4% |
| 1994 | $17,996,000,000 | 8.6% |
| 1993 | $16,571,000,000 | 9.1% |
| 1992 | $15,184,000,000 | |

Looking at the engagement ring market, for example, the estimated population of the United States by the Census Bureau at the end of 2004 was 294 million people. This information can be found at http://factfinder.census.gov/home/saff/main.html?_lang=en. The number of marriages during this period was 2.64 million, in which a diamond engagement ring was given 80% of the time. This gives a total of 2.1 million diamond engagement rings sold in 2004. Table 2 illustrates a projected market size of engagement rings sold in the U.S. for the next 4 years based on the Census Bureau data.

TABLE 2

| | Year | | | |
|---|---|---|---|---|
| | 2005 | 2006 | 2007 | 2008 |
| Population | 297,301,047 | 299,917,296 | 302,556,568 | 305,219,066 |
| Marriages | 2,675,709 | 2,699,256 | 2,723,009 | 2,746,972 |
| Engagement | 2,140,567 | 2,159,405 | 2,178,407 | 2,197,578 |
| Rings Sold | | | | |

As illustrated by predictions in Table 2, the population of the United States, the number of marriages, and the number of sales of engagement rings containing diamonds are expected to increase by 1-1.5% each year for the next several years. Unfortunately, couples marrying for the first time face roughly a 40-50% chance of divorcing in their lifetime. The median length for a first time marriage ending in divorce is eight years and, overall, 43 percent of marriages break up within 15 years. In fact, 43% of first marriages involve a partner who has been married at least once before and 54% of divorced women get married again within five years of being divorced. Thus, a portion of the market for engagement rings contains women who have been divorced at least once. Moreover, it is likely that a substantial percentage of divorced women who are to be married again (or even do not plan on getting married again) will retain their engagement ring.

Many retail outlets have return policies for products. The term product includes individual diamonds, diamond jewelry, individual colored gemstones, and any jewelry or jewelry related item. The return policies vary, some giving a full money back guarantee for any reason for a very limited period of time, usually 7-30 days. Other policies give store credit/exchange for the same period of time. In either case, the product must be returned in its original shape, i.e. undamaged, to obtain the refund. The refund or exchange benefit is generally not applicable to product that is engraved, inscribed or significantly altered.

As indicated in Table 2, in most cases a diamond is retained by its owner for a time period that exceeds the limited time period for a refund or exchange. If the owner of a diamond, for example, wishes to return it (e.g. after a divorce), the original seller may buy back the diamond at the current wholesale price or lower depending on the financial condition of the business. As diamonds are essentially a commodity, the wholesale prices do not tend to vary dramatically, generally increasing slightly from year-to-year.

Unfortunately, because the markup from the cost of product such as a diamond before operating expenses for a store is potentially large, the current wholesale price may be about 50% or less of the retail price paid for the product. The markup is large for product in general due to the relatively small amount of sales and relatively large expenses of the merchant such as inventory, security and theft prevention costs, property leasing, sales staff salaries, and marketing. The seller is thus unlikely to pay more than the wholesale price of the product. This tends to undermine the confidence of the owner in making a later purchase, as the value of the product may be significantly lower (usually 50-75%) than the initial amount paid. In addition, as the purchase appraisal of the product given for insurance purposes is normally at least the purchase price, this situation may also cause additional confidence problems if the owner has an insurance policy that covers product and finds out that the insurance premium he is paying is based on a coverage amount significantly higher than the cash replacement value.

In addition, often the various entities that provide the services in supplying the final product to the consumer must wait an extended period of time (for example, up to several months) to be paid for their goods and services. This is problematic and leads to higher prices.

### BRIEF DESCRIPTION OF THE DRAWINGS

FIG. 1 illustrates a flowchart of contracting for product and services and setting the price of product in one embodiment.

FIG. 2 illustrates a flowchart for order processing in one embodiment.

FIG. 3 illustrates a flowchart for product path in one embodiment.

FIG. 4 illustrates a flowchart for documentation in one embodiment.

FIG. 5 illustrates a flowchart of contracting for electronic tracking of documentation in an embodiment.

### DETAILED DESCRIPTION

In order to address the problems above, a system and method is described where the time of return for product is substantially increased and the product is coupled with insurance. By issuing an insurance policy with the purchase of the product, the original purchase price is guaranteed to be received by the purchaser at the time of return during the term of the insurance policy.

As described above, the limited return/exchange policies for product of various sellers are of limited merit due to the average length of time for the product to be returned. Merely increasing the guarantee period from the typical 30 day period may not be enough to attract a potential customer. That is, it may be unlikely that a purchaser will buy similar product from one merchant rather than another merely because the first merchant provides a 30 day full refund guarantee while the second merchant provides a 6 month full refund guarantee. Other factors may instead be more relevant to the decision of the purchaser regarding from whom to purchase the product. These factors can include, for example, cost of the product, location of the store or merchant selling the product, overall convenience to the purchaser, or any personal relationship between the purchaser (or recipient) and the merchant.

If prices are similar, an extended guarantee period may attract potential customers. However, it may not be feasible for a merchant to merely increase the guarantee period to the extent that it makes an impact on the purchaser. As the markup on the product cost tends to be larger than on other consumer goods, the merchant loses essentially all profit from the original transaction if an item is returned for a full refund. If the guarantee exists for an extended period of time, the merchant could be forced to liquidate his stock at lowered prices to pay his debts or even cause bankruptcy if the merchant is required to issue a large number of refunds in a relatively short time period. Moreover, if the guarantee exists for an extended period of time, the merchant could retire or go out of business for numerous reasons before the end of the guarantee period, leaving the owner of the product with no recourse if he or she wishes to return the product within the guarantee period but after the business is closed.

To alleviate these problems, a method of securing the value of the product to a purchaser or owner is described below. This method can take the form of, for example, a guarantee that is valid for an extended period of time and is coupled with insurance. More specifically, a method of obtaining an insurance policy issued and underwritten by an insurance carrier and coupling the insurance policy to the product when the product is sold to the purchaser is described. The coupling of third party insurance and product that substantially retains its value (also referred to as a supportable value product) permits a seller of the product to substantially increase the guaranteed return period to one or more years, if desired. This, combined with a decrease in the cost of product sold to below retail value and extensive product and retailing expertise, permit a seller to bring to market product at competitive pricing while offering protection to a customer, which will allow the customer to make lower risk purchases for the guarantee period. In the event that product is ordered, the product may be quickly prepared and shipped to the customer if not immediately available and the various entities (e.g. product supplier, insurance carrier, gem lab, manufacturer) may be paid within a short period of time, such as one or two business days.

In addition, by decreasing the gap between wholesale and retail cost there is greater incentive for the original seller to alleviate the need to use the insurance to buy back products. This, in turn, makes the sale of the insurance even more palatable to an insurance carrier and may result in lower costs. A portion of the insurance premiums may also be diverted to an escrow fund to pay claims during the term of the policy. This reserve fund may be eventually available to the merchant and partners of the merchant at the end of the exposure (guarantee) period when all liabilities have been satisfied.

Throughout this document, various terms are used. The owner of the product may be the original purchaser or legal heir of the original purchaser, who possesses a death certificate and trust and/or court documents indicating ownership (submission of claims by an heir may lengthen the refund process and require a transfer fee for the cost of verification). Ownership may be transferred via other means, such as resale of the product. Other entities described include a wholesaler, who is the producer and/or provider of product for the dealer.

The wholesaler may contract for Value Assurance Insurance (also referred to simply as insurance) through an insurance carrier. The wholesaler can be any combination of, but not limited to, the following jewelry industry classifications; sightholder, cutter, wholesaler, manufacturer, etc. The dealer may be the retail establishment contracted by the wholesaler to sell product to a consumer and handle returns from the consumer. Value Assurance Insurance is an insurance policy designed to provide a 100% money back assurance, at various rates and terms, on product purchased by the consumer. The insurance carrier is one or more insurance companies that provide the insurance. This may also be a consortium of entities providing insurance, reinsurance, claims processing and brokerage service. A broker is a licensed purveyor of insurance products. An administrator is one or more third party companies contracted by the insurance carrier and/or wholesaler to offer any combination of marketing, advertising, auditing, claims processing and consulting services. The administrator is an optional entity in the process if the carrier and/or wholesaler choose to perform any or all of these processes in-house.

The lab referred to herein is a gemological service that contracts with the insurance carrier and wholesaler to verify quality, authenticity and condition of the product, both prior to the product being sold to the dealer and upon return from the dealer, on behalf of the consumer and all parties to the process. The lab may also provide additional services such as laser inscription identification or the latest form of positive identification available.

As used throughout the specification, the term “Gross Margin” is defined as the ratio of gross profits divided by net sales, the term “Gross Profit” is defined as the net sales minus the cost of the goods, the term “Net Profit” is defined as the gross profit minus all operating expenses, the term “Net Profit Margin” is defined as the ratio of net profit divided by net sales, and the term “Markup” is defined as the amount added to the cost of product to give a retail price (price to the consumer). These and other definitions are standard accounting definitions and may be found in textbooks such as Intermediate Accounting 6^{th} Ed. by Kieso and Weygandt, John Wiley and Sons, 1989. The reserves are the capital withheld from premiums collected and/or capital contributed and held for the purpose of satisfying claims liability beyond projected losses. The premium is the amount charged to satisfy the risk associated with insurance liability. A central database is a server used to store any and all pertinent data related to any and all processes described herein. A WAN is a wide area network such as the internet or any other long distance information sharing system. A LAN is a local area network such as an internal computer network within a specific location.

Although the systems and methods described may be applied to various types of product if the durability, consistency in quality and resale value can be achieved, for convenience, the various embodiments described below generally refer only to diamonds and/or diamond jewelry. For example, in some embodiments diamonds whose wholesale cost typically does not vary significantly from year-to-year are subject to the guarantee and insurance. Significant variation, as defined herein, means a variation of more than about 5% per year. Diamonds are a prime example of product whose wholesale value historically has not varied significantly due to the method of the distribution, supply, demand and durability. The condition of a product deemed to have superior sales, visual beauty, re-salability, durability, appreciable value and insurability such that the product is suited to being re-purchased by the wholesaler in the event of return by a consumer is also called supportable value.

In the figures, a number of entities are described. These entities include a diamond supplier, insurance carrier, gem laboratory, jewelry manufacturer, finance company, retail and wholesale order center, fulfillment center and various retail and wholesale sellers. The diamond supplier has a cut or uncut diamond. If the diamond supplier has an uncut diamond, they may cut it themselves or supply it to a facility that cuts diamonds, i.e. a cutter, who returns the diamond after it is cut. The diamond is supplied from the diamond supplier to the grading lab. The diamond supplier may be the diamond cutter, a diamond wholesaler, or a diamond retailer, for example.

The grading lab may assess the light performance of the diamond and guarantees a high level of visual beauty on all purchases. The light performance may be assessed using a light source and a light detector, a computer that calculates the light path through the diamond using specialized software (beam tracing), and projects a three-dimensional image of the diamond showing the intensity and color of the light return on a display. Alternatively, the assessment of the light performance is determined using a photo-spectrometer that electronically analyses the returned light from projected light at multiple angles. A macro image of the diamond showing the intensity and color of the light return in approximately 90,000 pixels may then be displayed using sophisticated software. Due to the emerging industry of light performance technology, other methods of determining light performance may also be used.

Diamonds with superior brilliance can be ascertained and sold using any of these light performance assessment systems. The lab may also use micro photography to assist in grading and identification, or any other future applicable technology. The lab then may engrave the diamond with a unique identification via a laser beam or other engraving means. A lab report containing the identification of the diamond, image, the light performance assessment, and a complete summary is prepared and stored in a database maintained in the lab. Note that diamonds are graded on five standard characteristics; cut, clarity, color, weight and light performance (visual beauty). One or more of these characteristics may be determined using the Gemological Institute of America grading system, or any of a number of other internationally accepted grading systems, for example A.G.S. and H.R.D.

The lab then may send the diamond and the report to a jewelry manufacturer. A paper copy of the report can be sent with the diamond while an electronic copy of the report is transmitted to the manufacturer. The manufacturer produces a mounting, sets the diamond (making sure the laser inscription on the girdle edge is visible), polishes the mounting, quality checks the work, verifies the identity of the diamond via the laser inscription and delivers the finished jewelry to the fulfillment center. The manufacturer may be the diamond supplier who supplied the diamond to the lab or a separate entity. The manufacturer updates the electronic data to include the type of mounting as well as any other information. The manufacturer sends the diamond as well as transmitting the updated report to a fulfillment center, discussed below. In another embodiment, the lab may also provide these services rather than the manufacturer.

The preparation process described above can be performed on either reserved inventory or owned inventory. Reserved inventory is gemstones that are ordered by the merchant from the supplier and in which a specific amount is allocated for a period of time at a contracted price with the understanding that the supplier will be paid only for gemstones that are ultimately sold to a consumer or seller. Owned inventory is gemstones that are actually held and paid for by the merchant.

The lab also transmits the lab report to the merchant as well as the insurance carrier. The merchant acts as a central server of data, negotiates the various contracts between entities and coordinates payment to the various entities but does not, in general, physically handle the diamonds. The insurance carrier writes an insurance policy (the guarantee) based on the lab report. The insurance carrier stores the information and determines the cost of providing the insurance from the information provided thereto, the length of the guarantee period, and other pertinent information.

The various factors used in the determination can be stored in a computer and calculated by a processor using a particular algorithm stored in the computer. As diamonds are sold in lots in which the diamonds in the lot have similar characteristics, the policy can be based on the average characteristics of a diamond in the lot (i.e. a percentage of the average wholesale or retail price) or can be individualized to the characteristics of the particular diamond. The lot number of the diamond may be included in the information sent to the lab and in the identification etched into the diamond. Thus, the merchant can obtain the initial insurance policy on the diamond for the purchaser. The initial insurance policy is related to return of the diamond during the guarantee period and is incorporated into the purchase price. The purchaser or owner may purchase an extension of the guarantee period from the insurance carrier. The extension may be purchased from the insurance carrier directly or through the merchant. The policy information is transmitted to the fulfillment center. The fulfillment center may then send the policy, the lab report, and the jewelry to a customer when purchased. The merchant can additionally send marketing materials to the fulfillment center for distribution to retailers and/or consumers.

The fulfillment center transmits the diamond information as well as marketing materials to a retailer (or seller) who subscribes to the service offered by the fulfillment center. More specifically, the fulfillment center verifies the identity of the diamond via the laser inscription, prints the lab report, insurance document, and marketing materials (e.g. care and cleaning, registration process, upgrade process, return procedure, and warranty), photographs the item for verification of condition, and ships the item. The retailer advertises the jewelry and the guarantee to the public via any advertising medium, such as radio, television, newspaper, internet, and/or fliers, posters, or other physical advertisements. The retailer may include online websites, television shopping channels or programs, independent or chain jewelry stores, department stores, discount stores, and/or buying clubs. For example, the initial marketing of the diamond jewelry to consumers may take the form of television home shopping channels. One or more shopping channels, for example, may be selected to develop a live sales presentation and telephone order process. This allows the brand of the company offering the guarantee to receive greater exposure and strong selling opportunities quickly.

A customer who hears about the jewelry and guarantee may then place an order with an order center over the telephone or via the internet. The order center may be run by the retailer, the fulfillment center, or another entity. For example, if the retailer advertises on a television shopping network, the order center may be a part of the network. If the customer physically stops in the retailer's store, the order center may be within the store. The order center receives and processes the customer's request. The order center may process credit card payments from consumers. If the jewelry is purchased on an installment contract, the order center may transmit this information to a finance company that coordinates the contract. The order center may modify an electronic copy of a standard installment contract for the finance company with preset terms for the diamond at the time of purchase. If the diamonds are not immediately available from the fulfillment center, the order center may instead receive an order from a retailer at wholesale prices and provide the order to the merchant, who then orders diamonds of the desired quality from the seller.

The order center also transmits the request to the fulfillment center. In one embodiment, the fulfillment center is only for processing and shipping; it does not handle order acceptance. The merchant receives all orders and re-directs instructions to the various entities. The fulfillment center transmits the diamond information, insurance policy, marketing materials, and jewelry to the consumer. The fulfillment center provides this material to the customer in person or ships it to an address specified by the customer. The fulfillment center may retain a copy of the policy and lab report and/or transmit a copy to the retailer with whom the order was placed. The fulfillment center also transmits information to the insurance carrier regarding the diamond, retailer, and purchaser to the insurance carrier and merchant so that the insurance policy commences. If the diamonds are not immediately available, the entire process may take less than about 48 hours from order to supply to the consumer if all the entities that handle the diamond are located in a close geographical area. Verification of identity for those individuals applying for credit with a finance company might slow this process down depending on the method of verification used by the finance company.

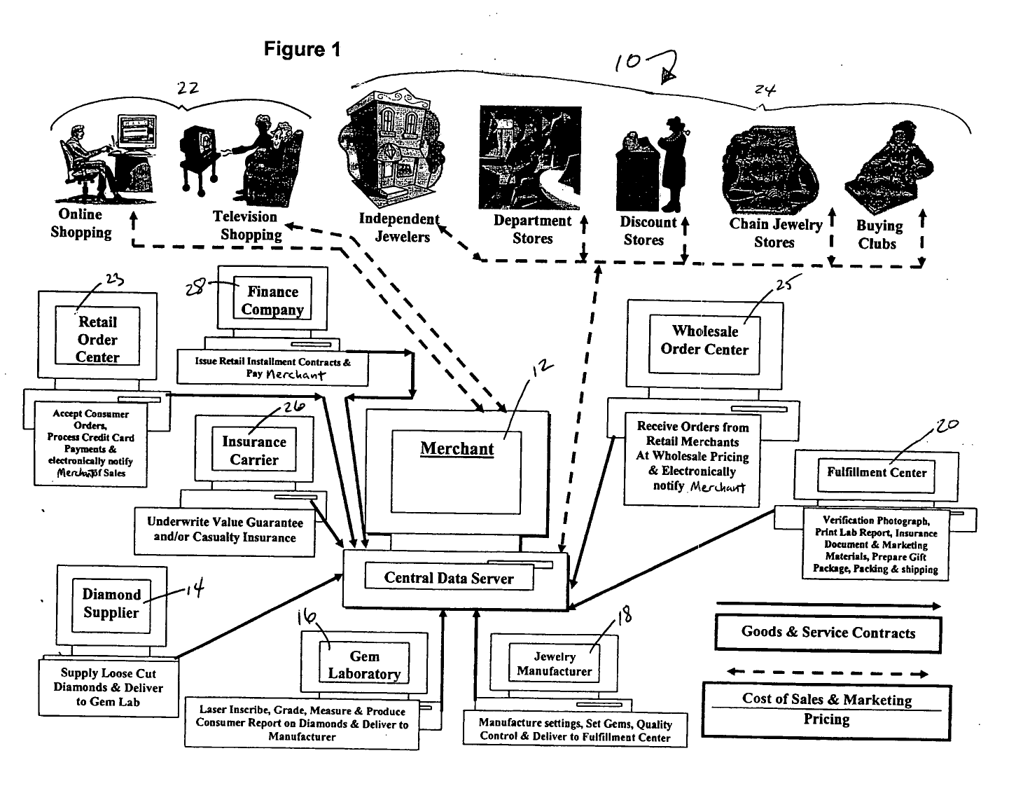

More specifically, FIG. 1 illustrates a flow diagram of contracting for products and services and setting the price of the product in one embodiment of a system 10 for linking gemstones to insurance. When setting the price, the merchant 12 negotiates a number of contractual agreements:

Short term guarantees of immediately availability and pricing (e.g. 30 days, 60 days, etc . . . ) are negotiated with the diamond supplier 14 for a pre-determined quantity of a specific weight and quality range of diamonds. (For example, 1000 0.50-0.59 carat, round brilliant diamonds, F-H (Gemological Institute of America (GIA) Gradations) body color, SI1-SI2 (GIA) clarity, superior light return in consistency, intensity and movement (scintillation) determined via electronic beam tracing and/or photospectromatic testing or other forms of testing. The merchant 12 negotiates pricing for the services of a gemological laboratory 16 for grading, laser inscribing, light performance testing, and delivery to a jewelry manufacturer 18 of processed diamonds. The merchant 12 engages in negotiations with the jewelry manufacturer 18 for manufacturing settings, setting diamonds, finishing, quality inspections, and delivery of finished jewelry to a fulfillment center 20. A contract is negotiated with the fulfillment center 20 for printing lab reports, insurance documents, and marketing materials to be packaged with the jewelry in appropriate presentation materials and for shipping the product to the retail 22 or wholesale 24 customer. The merchant also contracts with an insurance carrier 26 to underwrite the guaranteed cash value insurance policy to be coupled with the jewelry, possibly with property insurance as well. Typically, the merchant also negotiates with a finance company 28 for consumer credit programs that can be applied for either over the telephone or on the internet. Each of these negotiations is generally performed prior to any sale and may be performed concurrently.

The merchant 12 may have a computer that contains a memory in which weighing factors for the above characteristics are established. These weighing factors are periodically updated, either manually or automatically. The weighing factors are adjusted using one or more sources well known in the diamond industry to determine the wholesale price of the diamond. In one embodiment, the computer automatically logs in over the internet to one or more websites containing the wholesale information, downloads the data, and updates the weighing factors accordingly. The wholesale price for the diamond may be calculated directly from these factors by running a particular algorithm on the processor. Alternatively, the memory may contain prices for particular diamonds and the price of the actual diamond determined by the processor by extrapolating between the particular diamonds using a different algorithm.

The sale price of the diamond may be calculated using the wholesale price of the diamond and costs associated with the diamond, which are stored in the memory. These costs include, for example, insurance, mounting of the diamond, the laboratory costs for preparing the grading report, other operating expenses, and marketing and selling expenses. After the merchant calculates the fixed costs of manufacturing and distribution and sets the cost of the diamond, the merchant negotiates with television shopping networks, internet shopping websites, and various types of physical retailers (discounters and wholesalers) to sell and/or distribute the specific limited quantity guaranteed value jewelry.

As shown in FIG. 1, when products are sold, electronic orders are transmitted to the merchant. The merchant then notifies the diamond supplier who delivers a diamond to the gem lab. The gem lab notifies the merchant of the information after processing the diamond. Upon receipt of capital from the consumer or seller, the merchant 12 pays the various entities for products and services rendered.

The merchant 12 may be a holding company, clearing house for documentation and a cash flow redistribution point. The documentation can include contractual agreements with strategic partners. In this case, the merchant encounters reduced operating costs as there is no inventory expense, other than perhaps disposition of returned product. The merchant may choose to retain inventory, for example if product needs and potential sell through are able to be accurately determined. In one embodiment, inventory may be retained by the merchant prior to sale only if it results in higher profit margins without raising prices. The merchant, acting as a central coordinator, thus may have the buying power to obtain favorable rates from the various entities such as the supplier, the lab, the manufacturer, the fulfillment and order centers, and/or the insurance carrier. These lower rates may be passed on to the consumer.

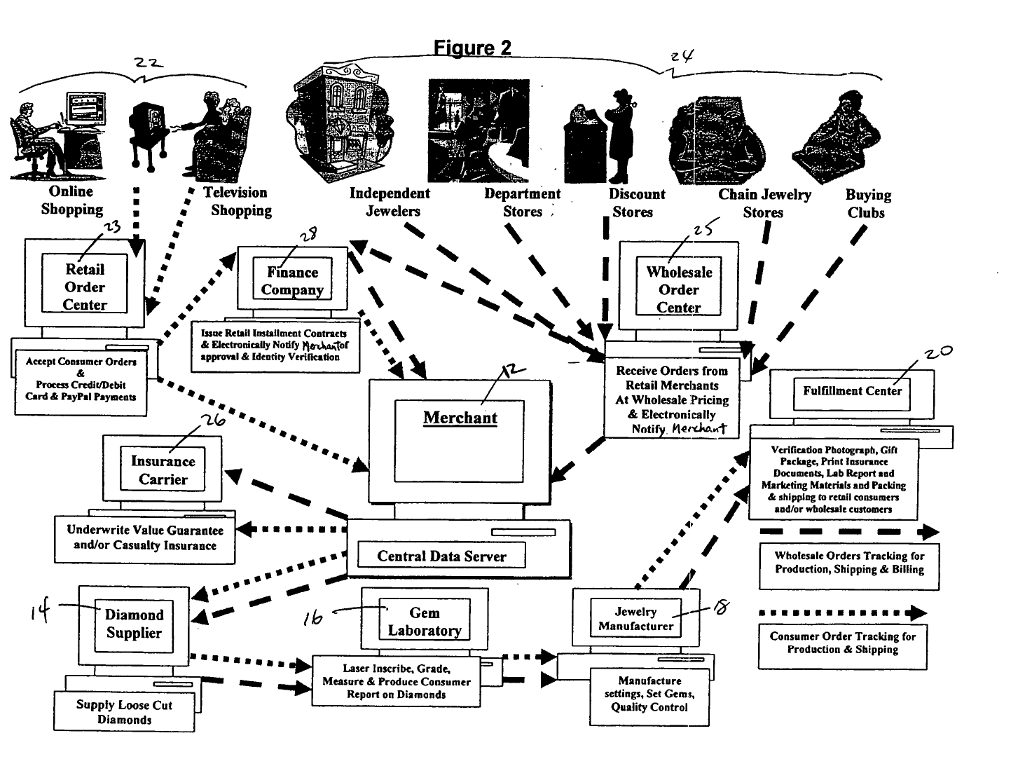

FIG. 2 illustrates one embodiment of order processing. If a retail consumer 22 orders over the internet or by telephone, the retail order center 23 accepts the consumer order, enters the appropriate data, and processes the credit card information. The retail order center 23 may disseminate the appropriate data to a finance company 28, which then issues an installment contract and forwards the information to the merchant.

In one embodiment, the retail order center 23 enters information into a website of the finance company 28, the finance company determines the credit status of the customer 22, issues a credit line and rate, and notifies the merchant 12 of the amount of credit, which the customer then uses to purchase product. In other embodiments, the customer can enter the information directly.

The retail order center 23 also informs the merchant 12 directly. The merchant informs the diamond supplier 14 so that a set of diamonds containing the particular diamond is ordered, if not available immediately by the fulfillment center 20. The consumer information is also sent to the insurance carrier by the merchant. If the diamond is ordered at a retailer 24, the wholesale order center 25 receives the order from a retail merchant at wholesale prices and supplies the information to the merchant 12. The merchant then sends the order to the diamond supplier 14. In either case, the order is processed by the supplier 14, and the materials and order are supplied to the gem lab 16, the jewelry manufacturer 18 and then to the fulfillment center 20.

As illustrated in FIG. 2, when an order is placed with the retail order center 23, a credit card number for the entire amount, a check, or an agreement initiating payments on an installment plan may be initiated by the consumer. The consumer may make an initial payment when placing the order. The installment plan can either be through the retailer, if purchased at a store, or set up by a third party. The retailer pays the merchant. As above, the merchant dispenses the funds it receives to the various entities involved with the transaction: the diamond supplier, the insurance carrier, the grading lab, the fulfillment center, and the jewelry manufacturer. All orders taken by telephone, internet, or retailers are cleared through the merchant 12 for proper tracking and billing. Methods of payment, especially finance company contracts processed without human verification, may incorporate procedures for verification of identity to avoid identity theft. The retailers may alternatively offer the product on a layaway basis that can either include insurance immediately upon purchase and/or upon subsequent delivery.

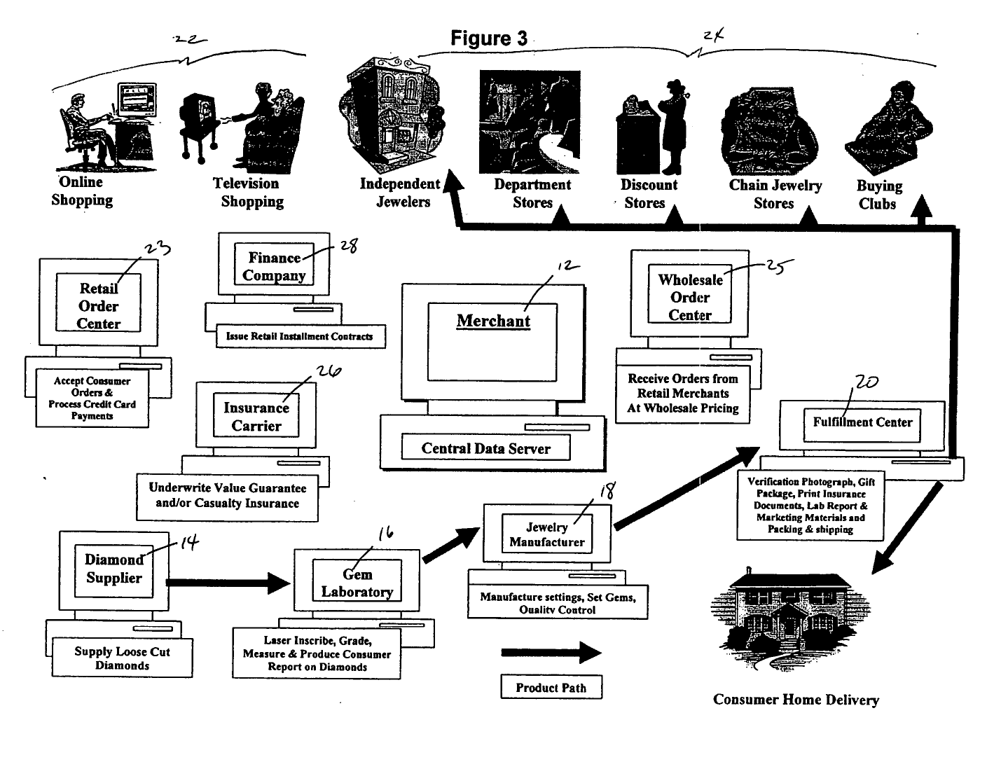

FIG. 3 illustrates a product flowchart in one embodiment. As shown, once an order for a particular set of diamonds is sent to the supplier 14, the supplier supplies loose cut diamonds to the lab 16. The lab evaluates the diamonds and inscribes a unique ID into each diamond. The lab sends the diamond along with the report containing the ID to the manufacturer 18. The manufacturer produces settings and mounts the diamond, and then supplies the diamonds to the fulfillment center 20. The fulfillment center supplies the diamonds to the store or retains the diamonds for delivery if ordered via the internet or television. If the diamond is ordered, the purchaser's information is transmitted from the order center to the fulfillment center, which then forwards the information to the merchant 12 and insurance carrier 26 to begin the guarantee period. The information is retained by the various parties at least until the guarantee period expires. The fulfillment center can also supply the diamonds to the consumer after instructed to do so by the order center. The policy information is supplied to the consumer through the merchant 12 and fulfillment center.

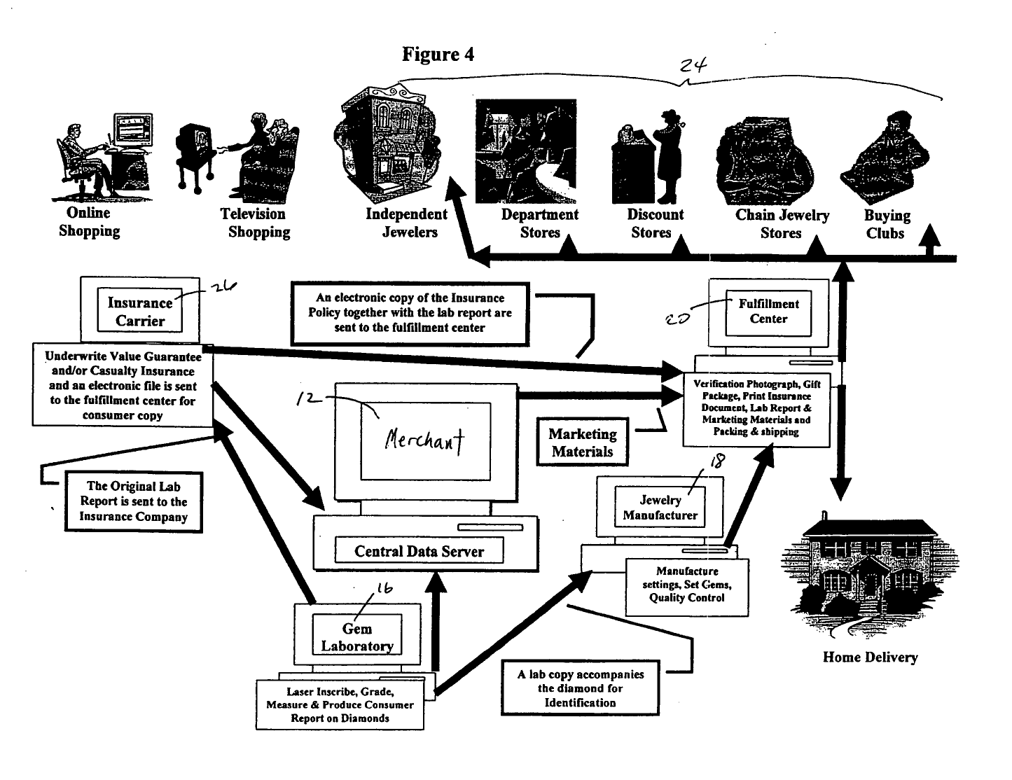

FIG. 4 illustrates one possible flow of physical documentation and/or electronic data in a sale of product. The laboratory quality analysis documentation is sent to the insurance carrier 26, the merchant/central data server 12, and the manufacturer. The diamond that is the subject of the report is also sent to the manufacturer 18. The documentation is sent to the insurance carrier 26 to establish criteria for the insurance policy. The original of the report may be sent to the insurance carrier. The insurance policy, together with the original lab report, is then sent to the fulfillment center by the insurance carrier. The mounted diamond, along with the copy of the lab report is also sent to the fulfillment center 20 by the manufacturer 18. Marketing materials are sent to the fulfillment center by the merchant. The fulfillment center 20 sends all of the documentation to the stores 24. The fulfillment center 20 additionally sends all of the documentation to the consumers once the diamond has been sold.

As indicated above, the insurance carrier 26 receives the documentation and insures all of the diamonds sold based on the documentation. The cost of the insurance to the merchant is relatively small. Although the insurance carrier insures the entire retail cost of the diamond, the insurance carrier does not have to assume the entire retail or wholesale cost of the diamond. The insurance carrier instead effectively insures the difference between the current wholesale price of the diamond and the original sale price of the diamond. This difference is smaller than either the current wholesale price of the diamond or the original sale price. Moreover, the original sale price remains constant and the current wholesale price of diamonds generally increases somewhat from year-to-year. This decreases the exposure of the insurance carrier and thus the cost to the merchant.

The insurance carrier may be a high profile, well respected, long standing insurance carrier such as Lloyds of London. If the seller goes out of business or is otherwise unable to refund the purchase price during the guarantee period, the insurance policy insures that the owner of the jewelry is paid the original purchase price by the insurance carrier. After the guarantee period, the merchant is no longer required to refund the original purchase price to the owner.

The merchant may advertise that he offers the guarantee/insurance, such as by displaying a special symbol. The guarantee assures that purchase price will be fully refunded without regard to the reason the jewelry is being returned, so long as the jewelry meets certain qualifications and is being returned by the rightful owner. Examples of the qualifications are provided below.

The guarantee may be extended to a year or more. In one embodiment, the guarantee could exist for several years, for example five years. Such a long guarantee is more likely to persuade a person who is going to purchase a piece of jewelry to purchase the jewelry from the merchant. The expected return rate of the jewelry over a period even as long as five years is less than 20%, however. The guarantee period starts when the diamond is first purchased from the merchant. If an attempt to return the diamond is initiated at the end of the guarantee period and more documentation regarding the rightful owner is desired by the merchant or insurance carrier, the insurance carrier may extend the guarantee period by a predetermined amount of time to gather the information (e.g. a week).

A return to the merchant and purchase by an entity that is not related to the original purchaser restarts the guarantee period. If the original purchaser returns the diamond and then repurchases the diamond, the guarantee period from the original purchase remains in effect. A related purchaser may be defined to include a spouse, sibling, child, parent, or any relation by blood or marriage to the original purchaser. In addition, a related purchaser may include a purchaser to whom the diamond was transferred at some point, directly or indirectly, from the original purchaser. The merchant and insurance carrier, accordingly, stores all transfers of the diamond (i.e. tracks the diamond) in the respective storage means to permit proper returns and stop improper extension of the insurance policy.

In one embodiment, only the original purchaser can return the diamond for the full refund. This is one way to maintain the guarantee, as the policy follows the purchaser, and avoids potential legal issues regarding property rights in the event of a failed engagement or marriage. It also creates fewer problems for the finance company in the event the consumer has outstanding debt against the property. A service charge may be assessed if the consumer decides to return a product for refund and subsequently buys the same product back. The consumer may also be subject to current market pricing at the time of re-purchase and the term of insurance may be determined based on whatever contractual rules are originally agreed upon by the carrier, wholesale and dealer.

In other embodiments in which the diamond is transferred, specific documentation indicating proof of ownership (e.g. notarized documents, etc.) may be supplied to the merchant. In such an embodiment, if ownership is transferred, the new information is transmitted to the appropriate parties by the merchant and subsequently retained. Specifically, the purchaser and/or owner contacts the merchant to indicate that the transfer has occurred. The merchant stores the identity of the new owner, linking it with the previous information, and transmits the information to the insurance carrier (and possibly finance company), who also links and stores the new information with the previous information stored by the insurance carrier. A service charge may be assessed for transfer of ownership.

If the purchaser or owner wishes to extend the coverage beyond the guarantee period, he or she can purchase insurance from the insurance carrier directly or through the merchant through an extension of the policy. The insurance can be a separate policy between the purchaser or owner and the insurance carrier. Alternatively, the extended guarantee period can be part of a homeowner or property policy of the purchaser or owner. A homeowner policy typically covers the owner's home and possessions inside the home against loss or damage. In this case, the homeowner policy would cover not only the loss of the diamond, but also return of the diamond.

The insurance carrier sets the time period in which the policy can be extended. For example, the insurance carrier can require an extension to be purchased at the time the diamond is bought. Alternatively, the insurance carrier can require the extension to be purchased within a set time after the diamond is bought, for example, 30 days to 1 or more years. The insurance carrier sets the rates dependent on various factors such as the purchase price of the diamonds, length of extension of the guarantee, financial status of the purchaser or owner, financial status of the merchant, and time of purchase of the extension policy. In a manner similar that used to calculate the original insurance cost, various factors can be stored in a computer and the rate calculated by a processor using a particular algorithm stored in the computer. As indicated above, as diamonds are sold in lots in which the diamonds in the lot have similar characteristics, the policy can be based on the average characteristics of a diamond in the lot, i.e. percentage of the average wholesale or retail price, or can be individualized to the characteristics of the particular diamonds sold.

In one embodiment, engraved, inscribed or custom-made jewelry as well as damaged jewelry or jewelry otherwise unable to be resold are not returnable under the guarantee. The particular merchant, however, can decide whether to refund any amount on his or her own. Engravings or inscriptions identifying a particular diamond, rather than personal engravings or inscriptions, remain under the guarantee. In another embodiment, the guarantee may be bundled with property insurance, for example, for diamonds purchased on finance contracts. This combination would permit the owner to receive a replacement of like and kind if the jewelry is damaged or lost.

As indicated above, in many instances a diamond is purchased on an installment plan. Once the initial sale is complete, the purchaser deals with a finance company when the installments become due. In this case, the diamond may be completely paid for or only partially paid for when a refund is requested. The period over which the installment plan runs can be longer or shorter than the guarantee period. In one embodiment, if the diamond is only partially paid for when the refund is requested, the merchant can opt to refund only the amount that has been paid and forego the other payments. In another embodiment, the diamond must be fully paid for before the total purchase price is amount refunded. In other words, the owner of the diamond must complete payment for the diamond before the full refund is issued. When the diamond is returned for a full refund, the person returning it may be required to sign (and perhaps notarize) a document stating that the diamond is completely paid for or authorizing payment of the remaining portion of the installment agreement to the finance company. In addition, the person returning the diamond may sign a document that releases the merchant from liability pertaining to payment of an installment agreement.

If an owner wishes to return the diamond, in one embodiment, (s)he notifies the merchant, who reviews the data on the diamond and owner. If the merchant determines that this is a valid return, the merchant sends a prepaid envelope addressed to the gem lab to the owner. The owner then returns the diamond to the gem lab via registered insured mail (or a similar means), where it is inspected for damage or alteration from when it was originally sold to the purchaser and for authentication. If the gem lab determines that the diamond is not damaged or altered, it notifies the merchant, who then sends a check to the owner. The diamond is then sent to the manufacturer for reconditioning and subsequent re-entry into the distribution system. In other embodiments, the owner may also return the jewelry in person to the seller, who then ships the return in a prepaid package to the gem lab.

To mitigate problems from fraud, in one embodiment, the number of returns of different diamonds may be limited for each entity, such as each individual or family (i.e. related individuals). The information regarding the returns may be stored by the merchant. This information may contain all returns from all sellers offering the guarantee. When a return is attempted, the merchant checks the history of the diamond and of the person/entity attempting the return on their computer or by calling the central location. If a return is close to the limit, for example within one or two times from the limit, the merchant is notified and the person attempting to return the diamond is informed that further attempts to return diamonds may result in the guarantee being voided. If the limit is reached, the guarantee may be voided and the merchant need not accept the diamond. This information may be transmitted to the owner verbally, when the owner is attempting to return the diamond, physically via letter, or electronically, via email or a secure website.

In cases of damaged or altered items, the merchant or a central coordinator may be the sole arbiter of the extent and value of the damages. When the merchant determines that the item is damaged, the merchant may deduct the amount of the repair from the amount to be returned (i.e. determine fair market value using industry standard valuation guidelines). Alternatively, the guarantee may be voided, e.g. if it is determined that the item may not be able to be resold.

Several product lines using diamonds may be developed. These product lines may include, for example, round diamond solitaire rings (primarily used as engagement rings), diamond stud earrings, and diamond solitaire pendants in various grade qualities. These and other categories may be chosen because they comprise about 25% of all retail jewelry sales. The volume of sales in the above categories for 2003 was estimated at $6.7 billion.

The diamonds in the product lines above, in one embodiment, may be in the size range of 0.33 carats to 1.5 (or more) carats. These sizes are among the most popular sizes. The quality ranges are dependant on consumer preferences, pricing/value, and availability in the market. In some markets, the quality ranges may be I (color) and SI2 (clarity) or better (GIA equivalent). As above, this grading is prepared independently by a third party laboratory, which may also laser inscribe a unique identification. The unique identification gives the customer complete trust in their purchase, as well as providing the insurance carrier some measure of comfort.

While the extended guarantee policy as well as insurance may draw some customers to buy diamond jewelry, additional incentive may be used to further increase the market share. As discussed above, the markup for diamonds is large and thus the price of diamond jewelry is relatively high. The high price may dissuade consumers from purchasing a diamond, or having to settle for a lesser diamond within their budget. The high price may also dissuade retailers from offering the guarantee as, at any point until the end of the guarantee period, the profit made from a particular sale may be disgorged.

By decreasing the markup for the diamond to a smaller, predetermined amount, the price of the diamond jewelry concomitantly decreases. In one embodiment, the markup is set by a single entity that controls the right to offer the guarantee through the insurance carrier. The markup is determined using a processor containing an algorithm to calculate the markup from various factors, such as estimated number of diamonds that will be sold over the period, competitive market research, and the minimum income needed by the merchant. The net margin, in one embodiment, is about 5-10% of the gross retail price of the diamond. Commensurate with industry standards, this results in slight lower competitive pricing due the streamlined marketing, production, and distribution methods. By offering diamonds of comparable quality for a much lower price or decreasing the jewelry price, additional market share of diamond sales can be captured and/or the amount of jewelry sold is likely to increase. This increase in sales volume should at least partially offset the loss in markup for selling a smaller volume of diamonds at a higher price. By lowering the markup, the amount of profit per returned diamond is less. As it is likely only a relatively small percentage of the diamonds will be returned, this means that the merchant does not suffer excessively from lost gross profit due to returns.

By streamlining the manufacturing and distribution process and lowering the need for excessive inventory, the retail price can be 30 to 50% lower than most current retail outlets and offer significantly greater supportable value. The net profit margin (the profit retained after cost of product and operating expenses) of between 5-10% for the merchant is similar to most industry standards and can potentially be maintained. Another potential benefit is an increase in consumer confidence as a result of the insurance company backing, which may lead to significantly increased sales by producing a low risk purchase for the consumer.

Although not specifically discussed in all cases, the information passed between the various entities can be transmitted as electronic data. The electronic data can be provided between individual entities or to a central server (maintained, for example, by the merchant) for dissemination to the desired entities. The electronic data can be transferred or copied from an electronic memory in a computer in one entity to a memory in another entity. The memory can be any memory capable of storing information, an electronic memory such as an EPROM (Electrically Programmable Read-Only Memory), EEPROM (Electrically Erasable Programmable Read-Only Memory), flash memory, CD (compact disc), DVD (digital video disc), or magnetic tape. Communications between the entities may be automatic, with updates occurring periodically and initiated by a processor of either entity, or when a flag is sent from a processor in the entity that contains the new data to a processor in the entity to which the new data is to be supplied. The electronic data may be sent to only one entity or may be available to one or more entities, for example, over the internet to view and/or download if the appropriate access code is used.

The various storage, calculation, and transmission stages may occur via electronic or non-electronic means. For example, information may be transmitted via telephone, email, secure website, fax, regular mail, and/or messaging. Storage can be in an electronic memory device or a physical file folder. Calculations can be accomplished by a processor in a computer or on paper using charts and tables. Storage, calculation and communication may take place at individual locations (for example, where a particular item was purchased) using individual processors or at a central location that contains all of the information gathered and uses one or more processors located at the central location. Alternatively, transactions may be orchestrated via electronic prompts from, and reports to, a server or other computer at a merchant. Retail customer orders may be directed to the merchant computer, or notification of an order may be sent to the merchant server, so that the various steps discussed herein of procurement, valuation, financing, insuring and transportation of the product may be initiated and/or tracked by the merchant server. In addition, the refund process may be automated and routed through the merchant server or other computer systems, such as that of the insurer.

In another embodiment, the business that sold the diamond may not be bankrupt but does not have the financial capital to refund the purchase price to the owner of the diamond. In this case, the insurance carrier refunds the purchase price and may give the business a right of first refusal before selling the diamond. When the insurance carrier offers the diamond for sale and a third party accepts the offer, a right of first refusal permits the business to have the first chance to purchase the diamond at the amount offered. The right of first refusal permits the merchant to absorb all returns back into the system at a particular price (such as around the wholesale price) or less and limits the exposure of the insurance carrier. In addition, this promotes lower premiums and gives the merchant the opportunity to limit the potential for liquidation by the insurance carrier at prices that might allow another seller to undermine the pricing structure of the product. Maintaining consistent retail pricing perpetuates the image of solid supportable value. The right of first refusal may be for all diamonds over a particular return percentage of sales or from a first return percentage up to a second return percentage, after which the insurance carrier can sell to the third party at any price.

In other embodiments, rather than the insurance carrier paying the owner of the product if the business cannot refund the purchase price, the insurance carrier may insure only the difference between the original wholesale price and retail (sale) price or a portion thereof, as determined by contract (i.e. insurance). Thus, the amount that the insurance carrier is responsible to repay is determined at the time the product is purchased. This set amount may keep premiums relatively lower than if the insurance carrier has to refund the entire retail price and then itself must determine how to resell the product. In the former case, the premium is based on the average return rate, the retail price, and the probability that the retailer will be unable to refund the sale price, which may be difficult to estimate. In the latter case, however, the premium is based on an easier calculated value: the average return rate and the average profit margin, which is much less than the retail price. The wholesaler and/or retailer may carry some of the burden for the premiums. The wholesaler and/or retailer may also have to pay additional fees, such as to buy into the insurance program, or to pay for advertising, for example.

In one embodiment, the insurance carrier pays the owner and is reimbursed by the wholesaler. The insurance carrier may retain the right to sell the product for a higher amount than the original wholesale price if the market exists. In other embodiments, the retailer may retain the right of first refusal at the original retail price. When the product is returned, before the purchase price is refunded, the product may be sent to the lab for verification and/or renewal of insurance. The new insurance contract and premiums may reflect a change in the wholesale or retail prices or difference therebetween.

In one example, when the product is returned and authenticated, the insurance carrier refunds the purchase price to the consumer, provides the product to the wholesaler or retailer in return for the wholesale price at the time of the original sale or in return for the wholesale price and a portion of the difference between the wholesale and retail prices. Alternatively, when the product is returned and authenticated, the retailer may refund the entire retail price to the owner, place the product back into inventory and submit a claim to the insurance carrier for a portion of the difference between the wholesale and retail prices.

Or, when the product is returned and authenticated, the retailer may refund the entire retail price to the owner, send the product back to the wholesaler and submit a claim to wholesaler or the insurance carrier for the wholesale price plus a portion of the difference between the wholesale and retail prices. In this case, if the wholesaler pays the retailer and retains the product, the wholesaler obtains a refund from the insurance carrier for the wholesale price and perhaps a fraction of the portion of the difference between the wholesale and retail prices. On the other hand, if the insurance carrier pays the retailer while the wholesaler retains the product, the insurance carrier obtains the wholesale price and perhaps a fraction of the difference between the wholesale and retail prices from the wholesaler.

To set up and implement insurance, a number of conditions may be met. These conditions include formation of a captive insurance carrier and/or negotiation with an existing insurance carrier to design and offer an insurance product. The captive insurance carrier may be located in a domicile suited to the best possible strategic and tax beneficial circumstance. The insurance product, as above, underwrites the difference of cost between the original purchase price amount refunded to the consumer, having previously purchased product from a dealer, and the partial reimbursement of the retail price paid for the product by the consumer, from the wholesaler and/or dealer. This may be done by any combination of insurance and/or re-insurance contract. One or more insurance brokers may also be contracted for policy issuance and licensing. One or more specialized insurance industry consultants or consulting firms may be hired for assistance in developing this process.

A contract is then developed between one or more carriers and one or more wholesalers. The contract may permit the wholesaler to produce a supportable value product for resale, to be distributed to a group of contracted dealers, potentially willing to accept a portion of the future consumer refund liability. The contract may provide for the wholesaler to purchase insurance from either the carrier or carrier's broker underwritten by either one or more existing/captive insurance companies, and/or one or more re-insurance partners to permit coverage of the gap between the refund of the original purchase price paid by the consumer and the refund liability amount agreed upon via contract by the wholesaler and/or dealer.

A contract may then be formed between the wholesaler and dealer. This contract may specify the guidelines of the process and the obligations of both parties. This may include a guarantee of profit for the retailer regardless of any returns. A waiting period for filing claims with the insurance carrier may exist. During this time, e.g. 120 days after sale and insurance registration of the product, the dealer may be responsible for 100% of any short term returns. A maximum limit of claims may be allowed before the dealer becomes responsible for 100% of their previous profit.

One or more third party companies may be contracted or formed to handle various responsibilities. These responsibilities may include selling the overall insurance concept to wholesalers and dealers, administrating the billing and auditing of insurance premiums, administrating the claims process, developing software for communications (including but not limited to web based applications), marketing, tracking and bookkeeping, maintaining a domicile and domicile manager for a captive, and developing and implementing a marketing and advertising strategy and campaign.

One or more gemological laboratories may be contracted for grading, identifying, laser inscribing, photographing, and documenting product for value assessment and future return verification. This can be done using any current and/or future technology in combination with visual inspection and application of jewelry industry accepted grading standards.

Staff and/or consulting services may be hired for developing electronic data storage and transmission software and hardware systems. A secure WAN communications network may be developed for real time information transfer between all involved parties including but not limited to the wholesaler, dealer, insurance carrier, lab, consumer, and any and all service subcontractors. A location may be established to serve as a base for the central database accessible via a WAN connection and/or LAN.

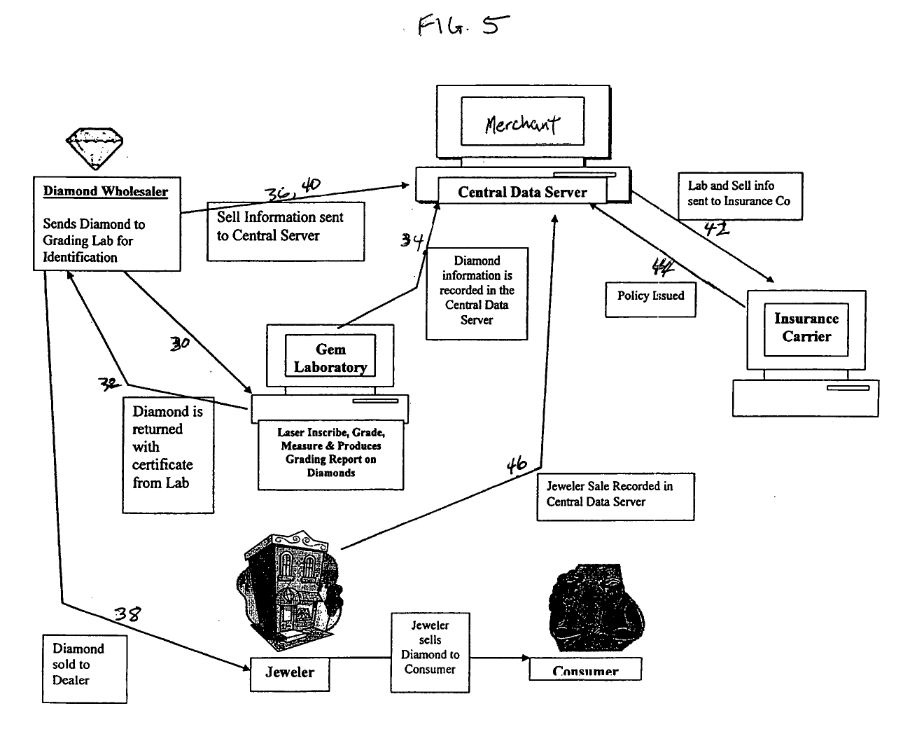

The product production and distribution process may be designed around a WAN environment. An example of electronic documentation tracking is shown in FIG. 5. In the process, the wholesaler may submit a projection of estimated periodic sales and aggregate value of product to be insured and prepay an insurance premium based on the estimate for the period agreed upon by the insurance carrier and wholesaler. The actual product insured may be audited and premium adjusted on a periodic basis at the discretion of the insurance carrier. The periodic basis may be, for example, monthly, quarterly, semi-annually or yearly. All WAN functions or transactions may contain electronic legally binding license agreements that are to be accepted prior to proceeding with the process, an example of which is discussed with reference to FIG. 5.

Referring now to FIG. 5, the wholesaler produces an amount and value of product that is consistent with the supportable value parameters agreed upon by the wholesaler and insurance carrier. The wholesaler sends the product to the lab for independent assessment (at step 30). The lab may do one or more of the following: laser inscribe, grade, measure, produce reports and return the product to the wholesaler (at step 32). The information derived may be placed on a printed or electronic report that may ultimately be given to the consumer and recorded, serialized, and/or stored in the central database via the WAN and/or LAN (at step 34). The individual grader responsible for submitting grading and identification information into the central data base via the WAN and/or LAN may be required to electronically agree to terms relating to their fiduciary responsibility to accurately and honestly submit information to the carrier. The lab and/or individual representative of the lab may be required to possess complete livability insurance for both the lab and the individual grader, which may contain but not be limited to errors and omissions, malfeasance, bonding and any other form of insurance deemed necessary by the carrier.

The wholesaler may list the newly created and documented product on both a closed dealer network at wholesale prices and a consumer accessible website showing suggested retail prices and available dealer locations. This data may be stored on the central database and be accessible via a WAN (at step 36). The product is sold to a dealer by the wholesaler (at step 38). Information pertinent to the details of the sale, which may include an electronic terms agreement accepted by the dealer and/or dealer's agent, is transmitted to, and recorded in the central database (at step 40). The administrator of the central database may then inform the insurance carrier of the sale (at step 42). One or more insurance policies for the product, as described above, may be issued and recorded in the central database by the insurance carrier or the insurance carrier's administrator (at step 44).

The product is then available to a consumer from the dealer. When the dealer sells the product to a consumer, the sale information may be entered into the insurance policy form by the dealer and registered in the central database (at step 46). This establishes the effective date of insurance coverage. The administrator of the central database may electronically notify all involved parties as to the status of the sale and subsequent insurance coverage. Written correspondence, which may be in the form of an electronic message, may also be sent directly to the consumer, informing them of the existence of coverage and the procedure for filing a legitimate claim. As described herein, the premium for the insurance policy on the products may be prepaid by the wholesaler. In this example, the wholesaler may provide an estimate on a periodic basis (e.g. quarterly) of the number of products it expects to ship to the insurance carrier and the insurance carrier may then invoice the wholesaler. Alternatively, the insurance premium may be paid upon shipment of products from a wholesaler to a dealer. In yet another alternative, the insurance premiums may be paid by the wholesaler automatically upon registration of a sale to a consumer by a dealer. In each of these examples, information on estimated volume of product, the actual product shipped to retailers, or the sale of a product to a consumer may be automatically disseminated to the insurance carrier via the WAN when the wholesaler or dealer enters information into central data server at the merchant 12 (see FIG. 1).

The refund process may contain several steps. The dealer may verbally inform the consumer, prior to the sale, of the written policy concerning the refund process. For example, the dealer may inform the consumer that the product is to be returned to the lab for verification of authenticity and non-damaged condition prior to the carrier issuing a refund. This process may normally take approximately 10 to 15 business days before a refund check is issued by the carrier. This process may be duplicated by the carrier's administrator in writing via U.S. Mail and/or electronically following the electronic registration of the product for insurance coverage.

The consumer may then return the product to an authorized dealer. The dealer may be the original dealer who sold the product or may be another participating dealer in the event the original dealer is no longer in business, contracted to represent the product line, or the consumer has moved to another geographical area. The dealer may have specially designed forms and packaging for giving the consumer a proper receipt for a shipping package that will be sealed in the presence of the consumer. A proper legal process for verification of ownership, such as multiple forms of identification, death certificate, certificate of sale from the original purchaser to the new owner, may be used.

If the product is mounted in a setting, it may be removed by the dealer in the presence of the consumer. Otherwise, the set product may be submitted intact as received from the consumer and condition will be verified by the lab. The dealer may connect to the WAN to notify the central database that a claim is being filed and the product is being sent to the lab for authentication and verification of re-salable condition.

The dealer may then ship the sealed package containing the product via overnight delivery or other insured service to the lab that evaluated the product prior to the sale. These services may include the U.S. postal service, registered or express mail, FedEx, or UPS. Upon receipt of the sealed package, the lab may document the receipt of the untampered package. Delivery may be refused if the package appears to be tampered with, thus ending the insurance claim process and referring it to the dealer who accepted the product for the return (or the original dealer) for compensation via shipping insurance. If this occurs, the lab may access the WAN to notify the central database. In the event of a tampered package, notification of denial of the claim with an explanation and recommended steps for processing a shipping loss may be sent to the consumer, dealer, wholesaler, administrator, and carrier by the central database administrator. The notification may be sent via email using the WAN and/or via U.S. mail or other delivery service.

If the package has remained sealed, the lab may open the package, retrieve the original electronic identification and quality assessment documentation for the product being received, and use this information for verification of authenticity, identification and condition using both visual examination and various forms of insurance carrier approved instrumentation. Upon verification of an undamaged and authentic product, if the documentation provided matches the original documentation, an electronic and/or written notice may be sent to the dealer, the consumer, the wholesaler, the central data base administrator and the carrier via the WAN and/or other delivery service. This notice may indicate that consumer claim will be processed for payment. If the product is damaged, the lab may notify the central database administrator who may subsequently send notices to all parties that the claim for insurance has been denied due to condition, and that the product will be returned to the dealer who accepted the product. This allows the consumer to retrieve the product and proceed with other options such as property insurance.

If the returned product is acceptable, the dealer may then be given a limited period of time, for example a 5 business day option, via the WAN from the central database administrator to exercise one of the following options:

1. Choose to keep the product in inventory with no future insurance option and purchase the product from the insurance carrier for the original retail value less the originally contracted liability mutually agreed upon by the dealer and wholesaler. For example, if the original dealer contract provided for the dealer to be responsible for 50% of the gross profit margin, in the event of an insurance carrier refund and the gross margin was 25% of the retail price, tiie liability would be 12.5% of the retail price. Thus, the dealer would pay the insurance carrier 12.5% of the original retail price plus the original wholesale price less the original insurance premium;

2. Choose to keep the product in inventory with a new insurance contract for the next consumer purchase. In this event, the original wholesaler may be required to fulfill their obligation to purchase the product from the insurance carrier for the original wholesale paid by the dealer less the original cost of insurance. The dealer may, in addition, be required to reimburse the insurance carrier for their originally contracted portion of the liability. The new terms of purchase for the product from the wholesaler to the dealer may be exercised based on the original dealer/wholesaler contract. This might require that the dealer pay the current wholesale value for the diamond inclusive of a new insurance fee at whatever terms are mutually agreed upon by the dealer and wholesaler.

3. Choose to decline future ownership of the product. In this circumstance, the product may be returned to and sold back to the original wholesaler or an alternative wholesale entity if a higher price were offered. The dealer may, in addition, be required to reimburse the insurance carrier for their originally contracted portion of the liability.

4. Exercise any of the above options, combined with a trade-in by the consumer where the consumer pays the difference between the current retail price of the new product less 100% of the price originally paid for the returned item. In this case, the dealer may be responsible for paying either the difference between the original wholesale price and the new wholesale price, or 100% of the new wholesale price in the event of option 1.

In another embodiment, if the dealer elects to return the product, the dealer's decision may trigger an automated auction. The automated auction may include the merchant notifying a closed network of the participating wholesalers and retailers for the purpose of listing the returned product for sale to the highest bidder. In one implementation, the product may be listed for 3 days and, if left unsold, sold to the original wholesaler at the original wholesale price. Since the product nas been inspected by the lab for authenticity and condition it may easily be re-introduced into the value assurance program. The dealer's initial decision to send the product back to the wholesaler may be communicated electronically to the merchant. Upon receipt of the communication, the merchant computer may automatically post the product for auction and transmit notices, via email for example, to the closed network of participating wholesalers and retailers.

Upon receipt of the dealer's preference by the carrier, the carrier may procure payment for the product from the dealer and wholesaler via electronic means (e.g. wire transfer, credit card, etc.). Upon fulfillment of the financial contractual obligations of the dealer and wholesaler to the carrier, the carrier may issue a check to the consumer for 100% of the original purchase price (sales tax not included). The refund check may be sent via U.S. postal service certified mail or other delivery service. The dealer's portion of any liability may also be collected by the wholesaler according the mutual agreement, leaving the wholesaler responsible for reimbursing the carrier for both the liability as well as that of the dealer. Any failure on the part of the wholesaler or dealer to pay their contracted share of liability may result in suspension or revocation of their future insurance contract with the carrier. The wholesaler may be responsible for all shared refund liability payments to the carrier.

As described, the supportable value product may be any of a number of items that maintain or increase in value and can be readily identified and authenticated. This may include, for example and without limitation, collectibles such as antiques or, as recited in the above discussion, loose gemstones such as diamonds. The diamonds may be natural and/or synthetic diamonds or other gemstones. These other gemstones, like diamonds, should be supportable value products able to be consistently priced throughout the jewelry industry through a set of standard characteristics. In addition, these gemstones may not be subject to wholesale price fluctuations as large as other gemstones, which limit exposures of the merchant and insurance carrier. Moreover, as the guarantee covers gemstones returned in their original condition, for customer satisfaction purposes the gemstones should be durable enough such that a large percentage of the gemstones do not get returned. In the case of products such as, but not limited to, artwork, collectables & antiques, etc., they are usually not worn and do not deteriorate in the fashion worn articles do. If they are cared for properly they may be insurable in the same manner as described above if they are both resalable and returned in pristine condition.

In one embodiment, the diamond price is calculated using the characteristics of the diamond and weighting factors for the characteristics, based on up-to-date information about the wholesale costs of the diamonds, expenses of the merchant, and a slight markup. In this embodiment, the markup is set by the merchant, who assumes the risk of losing essentially the entire markup as well as any expenses incurred if the diamond is returned. In other embodiments, the merchant provides the diamonds and insurance to individual sellers and gives a suggested price to the sellers. The sellers may sell the diamonds for more than the suggested price, but assume the losses for any amount over the suggested price. In one embodiment, each seller signs a contract agreeing to refund the purchase price or the price less any amount remaining to be paid to the owner and the merchant will not be responsible for paying for the difference between purchase price and the suggested price if the seller sets the purchase price above the suggested price. Conversely, the carrier may choose to only cover the amount the product is actually sold for up to the suggested retail value. The carrier may choose to insure the product for more than the suggested retail value with an additional premium.

Accordingly, a factor that may enhance the salability of diamonds is an extended guarantee period. The extended guarantee period may be implemented through a process of identifying quality diamonds and negotiating insurance coverage via a reputable insurance carrier. Diamonds are assessed for their light performance and are uniquely marked using laser-inscribed identification in the event of a return. All returns and exchanges are received through the gem laboratory so they can be properly inspected for condition and identity. The merchant determines whether to absorb the return into inventory and pay the refund or forward the item at the direction of the insurance carrier and authorize payment of a claim directly from the insurance carrier. The merchant makes this determination based on the current budget of the merchant at the time of return. The insurance carrier may solicit a renewal of the coverage after the initial term expires. In the event that a product is ordered by a consumer or seller, the product is quickly prepared and shipped to the customer if not immediately available and the various entities (e.g. diamond supplier, insurance carrier, gem lab, manufacturer) may be paid within one or two business days.

It is therefore intended that the foregoing detailed description be regarded as illustrative rather than limiting, and that it be understood that it is the following claims, including all equivalents, that are intended to define the spirit and scope of this invention.

We claim:

1. A method of providing a supportable value product, the method comprising:
procuring the supportable value product for a purchase price;
establishing a selling price for the supportable value product;
procuring from an insurance carrier an insurance policy on the supportable value product, the insurance policy setting a guarantee period for return of the supportable value product by an owner of the product; and
offering the supportable value product for sale at the selling price; and
reimbursing at least a portion of a profit margin of the product via the insurance policy when the product is sold by a merchant and returned within the guarantee period.

2. The method of claim 1, wherein the supportable value product comprises a diamond.

3. The method of claim 2, wherein establishing the selling price of the diamond comprises characterizing the diamond using cut, color, clarity, weight and dimensions as well as an assessment of light performance of the diamond.

4. The method of claim 1, wherein the guarantee period is at least one year.

5. The method of claim 4, wherein the guarantee period is at least five years.

6. The method of claim 1, further comprising inscribing a unique identification on the supportable value product before procuring the insurance policy.

7. The method of claim 1, wherein offering the supportable value product for sale comprises advertising the supportable value product on a shopping channel or over the Internet.

8. The method of claim 1, further comprising authenticating the returned supportable value product, the guarantee valid only if the returned supportable value product is in the condition in which the product was purchased.

9. The method of claim 1, further comprising procuring a right of first refusal for returned product from the insurance carrier.

10. The method of claim 1, wherein the insurance policy is procured by a wholesaler of the supportable value product.

11. The method of claim 1, wherein the merchant is responsible for a specific product return within a preset period after sale and insurance registration of the specific product.

12. The method of claim 1, wherein a wholesaler of the product submits a projection of estimated periodic sales and aggregate value of product to be insured and prepays a premium based on the estimate for a preset period.

13. The method of claim 1, wherein a wholesaler of the product lists the product on at least one of a closed dealer network at wholesale prices or a consumer accessible website showing retail prices and available dealer locations.

14. The method of claim 1, wherein the product may be returned to a dealer of the product who is authorized to received returned products.

15. A method of providing supportable value product, the method comprising:
establishing a selling price for the supportable value product;
establishing a guarantee period for return of the product by an owner of the product;
procuring from an insurance carrier an insurance policy on the product;
offering the product for sale at the selling price; and
establishing acceptance procedures for return of the product if a returned product is returned in a similar condition to a condition in which the product was purchased within the guarantee period, the insurance policy covering an amount of at most a profit margin of the product,
wherein the acceptance procedures include at least one of:
a dealer to whom the product was returned purchasing the returned product from the insurance carrier for the amount, the dealer choosing to retain the product with new insurance, a wholesaler purchasing the product from the insurance carrier for the purchase price less a cost of the insurance policy, and the dealer paying the wholesaler a current purchase price of the product and paying the insurance carrier the amount, the dealer declining ownership of the product, or permitting a trade-in by the owner where the owner pays a difference between a current selling price of a new product less the selling price of the returned product.

16. The method of claim 15, wherein the product comprises a diamond.

17. The method of claim 16, wherein establishing the selling price of the diamond comprises characterizing the diamond using cut, color, clarity, weight and dimensions as well as an assessment of light performance of the diamond.

18. The method of claim 16, wherein the guarantee period is at least one year.

19. The method of claim 15, wherein the insurance policy is procured by the wholesaler.

20. The method of claim 15, wherein the merchant is responsible for a specific product return within a preset period after sale and insurance registration of the specific product.

21. The method of claim 15, wherein the wholesaler submits a projection of estimated periodic sales and aggregate value of product to be insured and prepays a premium based on the estimate for a preset period.

22. The method of claim 15, wherein the wholesaler lists the product on at least one of a closed dealer network at wholesale prices or a consumer accessible website showing retail prices and available dealer locations.

23. The method of claim 15, wherein the product is returned to a dealer of the product who is authorized to received returned products.

24. A method of providing supportable value product, the method comprising:
establishing a wholesale price for a supportable value product;
establishing a retail price for the product;
procuring from an insurance carrier an insurance policy on the product, the insurance policy setting a guarantee period for return of the product by an owner of the product if the product is in a similar condition as when purchased and establishing a payment to a merchant who sold the product of at most a portion of the retail price less the wholesale price of the product;
offering the product for sale at the retail price; and
refunding the selling price to the owner if all of a set of predetermined conditions of a return have been met by the owner.
